(19) United States
(12) Patent Application Publication
(10) Pub. No.: US 2025/0009182 A1
(43) Pub. Date: Jan. 9, 2025

(54) LID STRUCTURE OF MIXER

(71) Applicant: Homer electric appliance Co., Ltd, Shenzhen (CN)

(72) Inventor: Lefan Xu, Shenzhen (CN)

(21) Appl. No.: 18/886,259

(22) Filed: Sep. 16, 2024

(30) Foreign Application Priority Data
Apr. 9, 2024 (CN) 202420714803.2

(51) Int. Cl. A47J 43/046; A47J 43/07

(52) U.S. Cl. CPC A47J 43/046; A47J 43/0716

(57) ABSTRACT

The present disclosure discloses a lid structure of a mixer, and belongs to the technical field of food mixers, including a shredding lid and a cup body. A small push rod for shredding and a large push rod for shredding are respectively arranged in the shredding lid; a bottom end of the shredding lid is connected to a button bracket; a bottom end of the button bracket is connected with a cup lid sliding block; a bottom end of the cup lid sliding block is connected with a single cup lid sliding block; and an inner side wall of a groove at a top end of the cup lid sliding block is connected with two connecting rod sliding blocks. According to the present disclosure.

### TECHNICAL FIELD

The present disclosure relates to the technical field of food mixers, and in particular to, a lid structure of a mixer.

### BACKGROUND

A food mixer is a small machine that can mix various fruits and vegetables to squeeze the fruits and vegetables into fresh and delicious fruit and vegetable juice. The working principle of the food mixer is to repeatedly crush the food under the action of water flow by high-speed rotation of blades at a bottom of a mixing cup.

At present, square mixing cups in most existing stand mixers do not have a buckle structure, and only a very small number of stand mixers have a very complex locking mechanism for the square mixing cups. Due to a need for reserving a cup lid fixing structure and a drive mechanism space for a drive assembly in a cup, the drive assembly would jack up the cup lid during working. As a result, the mixer cannot work normally, and there is a potential safety hazard.

### SUMMARY

To solve the problem that there is no locking structure that is stably and conveniently used for a square mixing cup in a stand mixer in the prior art, the present disclosure provides a lid structure of a mixer.

To achieve the above objective, the present disclosure provides the following technical solutions:

A lid structure for a mixer includes a shredding lid and a cup body; a small push rod for shredding and a large push rod for shredding are respectively arranged in the shredding lid; a bottom end of the shredding lid is connected to a button bracket; a bottom end of the button bracket is connected with a cup lid sliding block; a bottom end of the cup lid sliding block is connected with a single cup lid sliding block; an inner side wall of a groove at a top end of the cup lid sliding block is connected with two connecting rod sliding blocks; inner side walls of circular holes provided on the connecting rod sliding blocks are connected with connecting rod hinges; pin shafts on the connecting rod hinges are rotatably connected with cup lid connecting rods; the cup lid connecting rods are connected with limiting sliding blocks through reset springs; a trigger assembly is arranged on the button bracket; an outer side wall of the cup body is connected with a handle; a pop-up assembly is arranged in the handle; a cup seat lid is arranged in the cup body; a large cup seat is arranged below the cup seat lid; and a mashing assembly and a shredding assembly are arranged in the cup body.

Preferably, the bottom end of the button bracket is fixedly connected to the top end of the cup lid sliding block; the bottom end of the cup lid sliding block is slidably connected to a top end of the single cup lid sliding block; a side wall of the single cup lid sliding block is fixedly connected with a cup lid buckle spring; and the other end of the cup lid buckle spring is fixedly connected to the cup lid sliding block.

Preferably, the trigger assembly is composed of a release button and a button spring; the button spring sleeves an outer side wall of the release button; a bottom end of the button spring is fixedly connected to a top end of the button bracket; and an inner side wall of an insertion hole provided on the button bracket is slidably connected to a side wall of the release button.

Preferably, side walls of the two connecting rod sliding blocks are slidably connected to an inner side wall of a sliding chute on the cup lid sliding block; inner side walls of shaft holes provided on the connecting rod sliding blocks are rotatably connected to outer side walls of the pin shafts on the connecting rod hinges; bottom ends of the cup lid connecting rods are slidably connected to the limiting sliding blocks; and two ends of the reset springs are respectively fixedly connected to the cup lid connecting rods and the limiting sliding blocks.

Preferably, the limiting sliding blocks and the single cup lid sliding block are respectively movably connected to a transparent lid for shredding; an outer side wall of the small push rod for shredding and an outer side wall of the large push rod for shredding are respectively movably connected to an inner side wall of the transparent lid for shredding; a bottom end of the transparent lid for shredding is fixedly connected with two cup lid connecting shafts; and a cup lid sealing ring is arranged at the bottom end of the transparent lid for shredding.

Preferably, the pop-up assembly is composed of a left large cup ejector rod and a right large cup ejector rod; an outer side wall of the cup body is fixedly connected to two ends of the handle; side walls of the left large cup ejector rod and the right large cup ejector rod are slidably connected to an inner side wall of the handle; and bottom ends of the left large cup ejector rod and the right large cup ejector rod are fixedly connected with ejector springs.

Preferably, a knife rod connecting head is arranged in the cup body; a bottom end of the knife rod connecting head is fixedly connected with a rotating shaft; an outer side wall of the rotating shaft is connected with an upper gasket; a the bottom end of the rotating shaft is connected with a bearing sleeve; and a bottom end of the bearing sleeve is connected with an oil seal and an oil bearing.

Preferably, a bottom end of the cup seat lid is adaptively connected to a top end of a large cup seat; a decorative ring is arranged on an outer side wall of the large cup seat a cup seat spring buckle is arranged in the large cup seat; a top end of the cup seat spring buckle is fixedly connected with a snap spring, a lower gasket is provided on the bottom end of the cup seat spring buckle; and a bottom end of the large cup seat is connected with a large cup connecting head through a connecting nut.

Preferably, the mashing assembly is composed of a mashing cutterhead fixing seat and a mashing cutterhead; the mashing cutterhead is arranged below the mashing cutterhead fixing seat; the mashing cutterhead fixing seat is connected to the mashing cutterhead through a mashing shaft; and a bottom end of the mashing cutterhead is fixedly connected with a shredding knife connecting shaft.

Preferably, the shredding assembly is composed of an upper shredding cutterhead fixing seat, a shredding cutterhead, and a lower shredding cutterhead fixing seat; an outer side wall of the shredding knife connecting shaft is fixedly connected with a shredding insert; the shredding cutterhead is respectively connected to the upper shredding cutterhead fixing seat and the lower shredding cutterhead fixing seat; and an inner side wall of the lower shredding cutterhead fixing seat is adapted to an outer side wall of a top end of a shredding knife rod.

Compared with the prior art, the present disclosure has the beneficial effects below:
1. In this solution, by the arrangement of the limiting sliding block, the single cup lid sliding block, and the release button, when the shredding lid is pressed, protruding portions of the limiting sliding block and the single cup lid sliding block telescopically enters limiting slots in the cup body for locking. After the mixing is completed, the release button is pressed to remove the limiting sliding block and the single cup lid sliding block from the limiting slots to relieve the limitation, so that spilling of a food material caused by protrusion during mixing is avoided; and meanwhile, it is convenient to quickly relieve the locking limitation after the mixing is completed.
2. In this solution, by the arrangement of the cup lid connecting shafts and the ejector springs, it can be convenient for a user to directly open the shredding lid after the locking limitation is relieved, so that the operation of opening the shredding lid is more convenient and quicker.
3. In this solution, by the arrangement of the mashing cutterhead and the shredding cutterhead, different crushing and mixing cutterheads can be selected according to the features of different food materials, to meet different use needs of a user, so that the mixer has higher applicability.

### BRIEF DESCRIPTION OF THE DRAWINGS

FIG. 1 is a schematic diagram I of a three-dimensional structure of a lid structure of a mixer provided by the present disclosure;

FIG. 2 is a schematic diagram II of a three-dimensional structure of a lid structure of a mixer provided by the present disclosure;

FIG. 3 is a schematic structural diagram of a button in a lid structure of a mixer provided by the present disclosure;

FIG. 4 is a schematic structural diagram of an ejector spring in a lid structure of a mixer provided by the present disclosure;

FIG. 5 is a schematic structural diagram of a large cup seat in a lid structure of a mixer provided by the present disclosure;

FIG. 6 is a schematic structural diagram of a mashing cutterhead in a lid structure of a mixer provided by the present disclosure;

FIG. 7 is a schematic structural diagram of a shredding cutterhead in a lid structure of a mixer provided by the present disclosure;

FIG. 8 is a schematic structural diagram of a single cup lid sliding block in a lid structure of a mixer provided by the present disclosure;

FIG. 9 is a schematic structural diagram of a button bracket in a lid structure of a mixer provided by the present disclosure; and

FIG. 10 is a schematic structural diagram of a cup seat lid in a lid structure of a mixer provided by the present disclosure.

In the drawings: 1: shredding lid; 2: cup body; 3: small push rod for shredding; 4: large push rod for shredding; 5: release button; 6: connecting rod sliding block; 7: connecting rod hinge; 8: cup lid connecting rod; 9: reset spring; 10: limiting sliding block; 11: button spring; 12: button bracket; 13: cup lid sliding block; 14: single cup lid sliding block; 15: cup lid buckle spring; 16: transparent lid for shredding; 17: cup lid connecting shaft; 18: cup lid sealing ring; 19: handle; 20: left large cup ejector rod; 21: right large cup ejector rod; 22: ejector spring; 23: knife rod connecting head; 24: rotating shaft; 25: upper gasket; 26: bearing sleeve; 27: oil seal; 28: oil bearing; 29: cup seat lid; 30: decorative ring; 31: snap spring; 32: cup seat spring buckle; 33: large cup seat; 34: lower gasket; 35: connecting nut; 36: large cup connecting head; 37: shredding cutterhead fixing seat; 38: mashing cutterhead; 39: shredding knife connecting head; 40: shredding insert; 41: upper shredding cutterhead fixing seat; 42: shredding cutterhead; 43: lower shredding cutterhead fixing seat; and 44: shredding knife rod.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all of the embodiments. Based on the embodiments of the present disclosure, all other embodiments obtained by those of ordinary skill in the art without creative work shall fall within the scope of protection of the present disclosure.

### Embodiment I

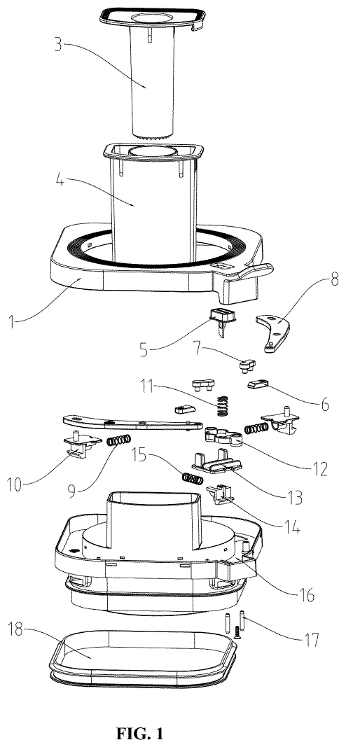

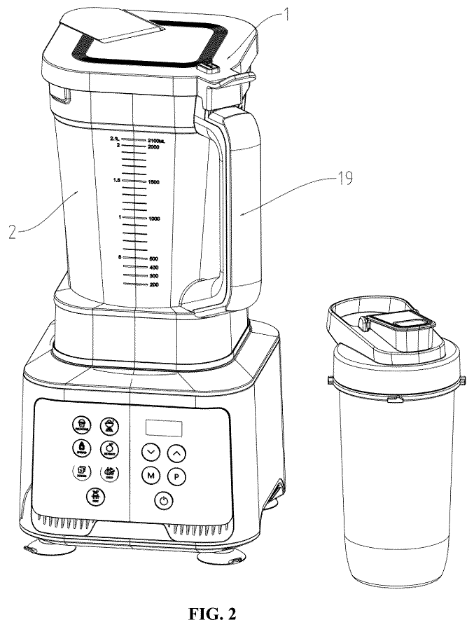

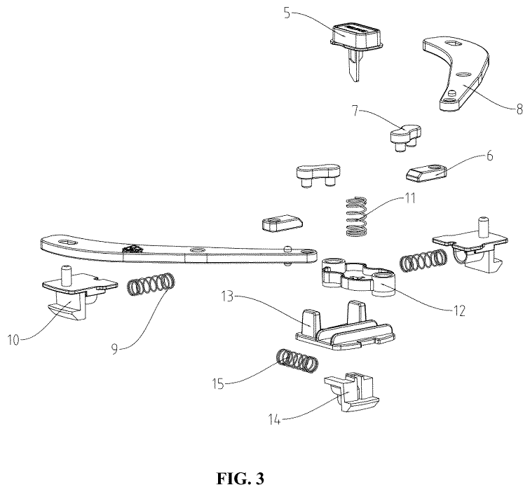

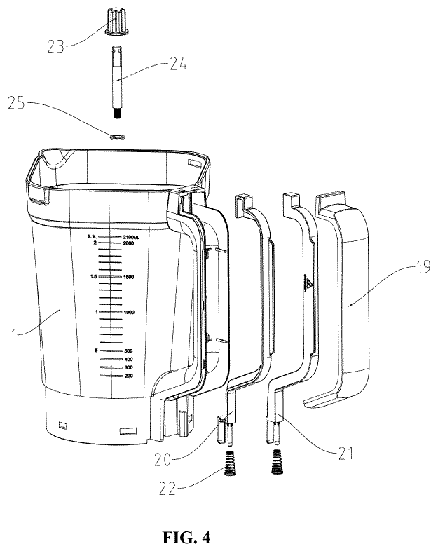

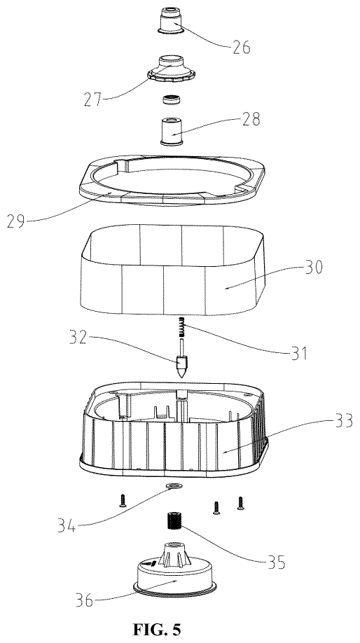

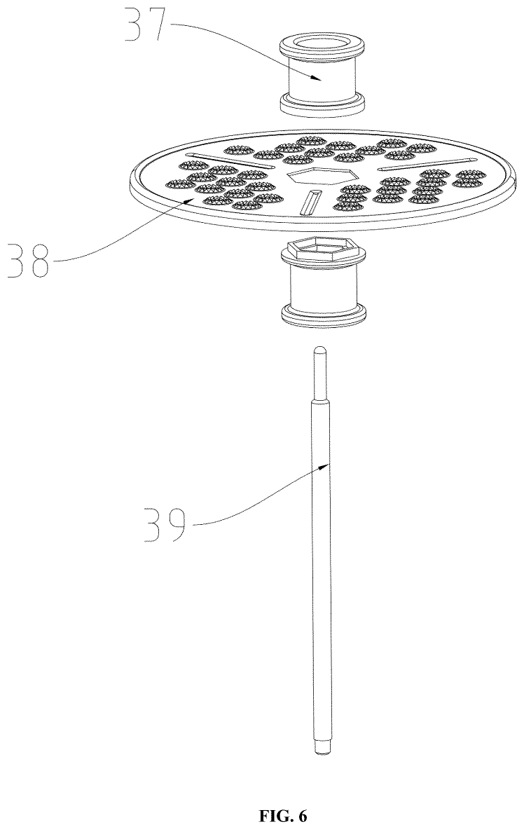

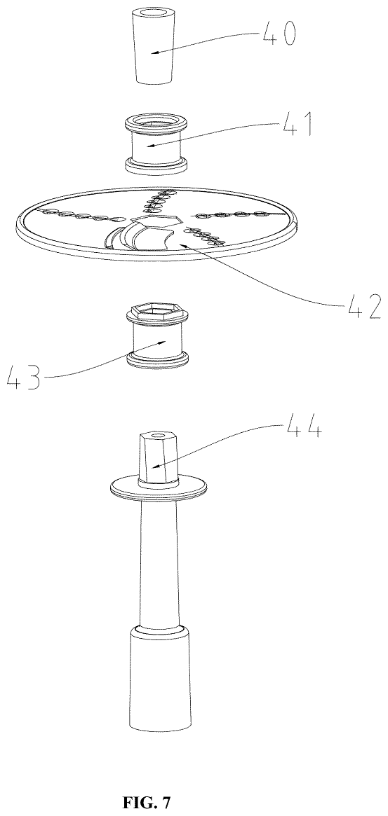

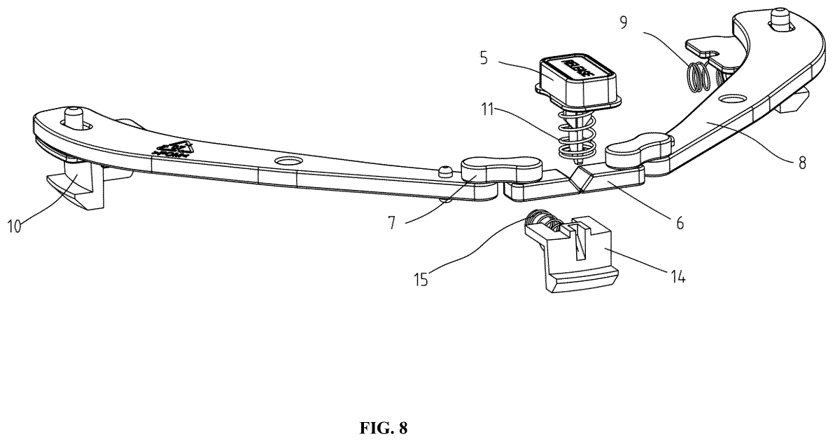

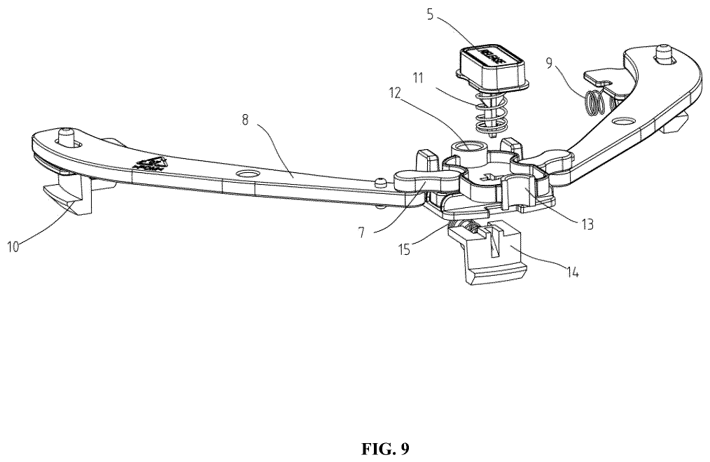

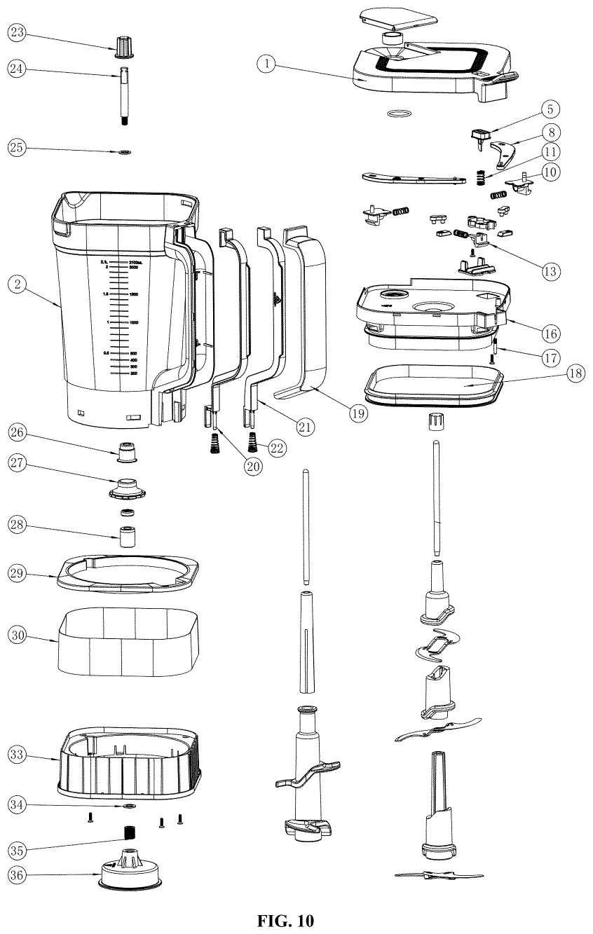

Referring to FIG. 1 to FIG. 10, a lid structure for a mixer includes a shredding lid 1 and a cup body 2; a small push rod 3 for shredding and a large push rod 4 for shredding are respectively arranged in the shredding lid 1; a bottom end of the shredding lid 1 is connected to a button bracket 12; a bottom end of the button bracket 12 is connected with a cup lid sliding block 13; a bottom end of the cup lid sliding block 13 is connected with a single cup lid sliding block 14; an inner side wall of a groove at a top end of the cup lid sliding block 13 is connected with two connecting rod sliding blocks 6; inner side walls of circular holes provided on the connecting rod sliding blocks 6 are connected with connecting rod hinges 7; pin shafts on the connecting rod hinges 7 are rotatably connected with cup lid connecting rods 8; the cup lid connecting rods 8 are connected with limiting sliding blocks 10 through reset springs 9; and a trigger assembly is arranged on the button bracket 12.

Further, the bottom end of the button bracket 12 is fixedly connected to the top end of the cup lid sliding block 13; the bottom end of the cup lid sliding block 13 is slidably connected to a top end of the single cup lid sliding block 14; a side wall of the single cup lid sliding block 14 is fixedly connected with a cup lid buckle spring 15; and the other end of the cup lid buckle spring 15 is fixedly connected to the cup lid sliding block 13. The trigger assembly is composed of a release button 5 and a button spring 11; the button spring 11 sleeves an outer side wall of the release button 5; a bottom end of the button spring 11 is fixedly connected to a top end of the button bracket 12; and an inner side wall of an insertion hole provided on the button bracket 12 is slidably connected to a side wall of the release button 5. Side walls of the two connecting rod sliding blocks 6 are slidably connected to an inner side wall of a sliding chute on the cup lid sliding block 13; inner side walls of shaft holes provided on the connecting rod sliding blocks 6 are rotatably connected to outer side walls of the pin shafts on the connecting rod hinges 7; bottom ends of the cup lid connecting rods 8 are slidably connected to the limiting sliding blocks 10; and two ends of the reset springs 9 are respectively fixedly connected to the cup lid connecting rods 8 and the limiting sliding blocks 10. The limiting sliding blocks 10 and the single cup lid sliding block 14 are respectively movably connected to a transparent lid 16 for shredding; an outer side wall of the small push rod 3 for shredding and an outer side wall of the large push rod 4 for shredding are respectively movably connected to an inner side wall of the transparent lid 16 for shredding; a bottom end of the transparent lid 16 for shredding is fixedly connected with two cup lid connecting shafts 17; and a cup lid sealing ring 18 is arranged at the bottom end of the transparent lid 16 for shredding.

It should be noted that: After a food material to be crushed and mixed is put into the cup body 2, the two cup lid connecting shafts 17 at the bottom end of the shredding lid 1 are aligned with the shaft holes at the handle 19 at the top end of the cup body 2; the entire shredding lid 1 is then closed and pressed downwards; pressing the shredding lid 1 downwards will press the cup lid sliding block 13 and the single cup lid sliding block 14 together; pressing the single cup lid sliding block 14 downwards may press its protruding portion to deform and enter the limiting slot provided on the inner side wall of the cup body 2; the down movement of the cup lid sliding block 13 will drive the connecting rod sliding blocks 6 to move down together, so that the connecting rod sliding blocks 6 will drive the cup lid connecting rods 8 to move downwards through the connecting rod hinges 7; and the down movement of the cup lid connecting rods 8 will drive the limiting sliding blocks 10 to move downwards, so that protruding portions of the limiting sliding blocks are pressed to deform and enter the limiting slots provided in the cup body 2, thereby completing the locking on the entire cup lid. After the crushing and mixing are completed, the release button 5 is pressed, and the release button 5 will compress the button spring 11 to downwards pass through the insertion hole provided on the button bracket 12. After the release button 5 is inserted into the two connecting rod sliding blocks 6, the two connecting rod sliding blocks 6 slide outwards, and the connecting rod sliding blocks 6 will rotate together with the connecting rod hinges 7. The connecting rod hinges 7 will rotate to drive the cup lid connecting rods 8 to rotate together, so that the cup lid connecting rods 8 rotate outwards, and the limiting sliding blocks 10 are separated from the limiting slots in the cup body 2. The release button 5 continues to move downwards to pass through the cup lid sliding block 13 and be inserted onto a slope of the single cup lid sliding block 14, making the single cup lid sliding block to slide inwards and be separated from the limiting slot of the cup body 2.

A further advantage of the above solution is as follows: This can quickly complete the locking on a square cup of the mixer, avoid spilling of the food material caused by a protrusion during mixing, and further facilitate quickly relieving the locking limitation after the mixing is completed. It is more convenient to use.

### Embodiment II

Referring to FIG. 1 to FIG. 10, an outer side wall of the cup body 2 is connected with a handle 19; a pop-up assembly is arranged in the handle 19; and a cup seat lid 29 is arranged in the cup body 2.

Further, the pop-up assembly is composed of a left large cup ejector rod 20 and a right large cup ejector rod 21; an outer side wall of the cup body 2 is fixedly connected to two ends of the handle 19; side walls of the left large cup ejector rod 20 and the right large cup ejector rod 21 are slidably connected to an inner side wall of the handle 19; and bottom ends of the left large cup ejector rod 20 and the right large cup ejector rod 21 are fixedly connected with ejector springs 22. A knife rod connecting head 23 is arranged in the cup body 2; a bottom end of the knife rod connecting head 23 is fixedly connected with a rotating shaft 24; an outer side wall of the rotating shaft 24 is connected with an upper gasket 25; a the bottom end of the rotating shaft 24 is connected with a bearing sleeve 26; and a bottom end of the bearing sleeve 26 is connected with an oil seal 27 and an oil bearing 28. A bottom end of the cup seat lid 29 is adaptively connected to a top end of a large cup seat 33; a decorative ring 30 is arranged on an outer side wall of the large cup seat 33; a cup seat spring buckle 32 is arranged in the large cup seat 33; a top end of the cup seat spring buckle 32 is fixedly connected with a snap spring 31, a lower gasket 34 is provided on the bottom end of the cup seat spring buckle 32; and a bottom end of the large cup seat 33 is connected with a large cup connecting head 36 through a connecting nut 35.

It should be noted that: When the two cup lid connecting shafts 17 at the bottom end of the shredding lid 1 are aligned with the shaft holes at the handle 19 at the top end of the cup body 2 and are pressed, the cup lid connecting shafts 17 will press the left large cup ejector rod 20 and the right large cup ejector rod 21. When the left large cup ejector rod 20 and the right large cup ejector rod 21 are pressed, the two ejector springs 22 will be compressed for energy storage. After the subsequent crushing and mixing are completed, the release button 5 is pressed to relieve the locking limitation, and the left large cup ejector rod 20 and the right large cup ejector rod 21 may eject the two cup lid connecting shafts 17 under the action of the elastic force of the ejector springs 22, thereby making the entire shredding lid 1 to pop up.

A further advantage of the above solution is as follows: This can be convenient for a user to directly open the shredding lid 1 after the locking limitation is relieved, so that the operation of opening the shredding lid 1 is more convenient and quicker.

### Embodiment III

Referring to FIG. 1 to FIG. 10, a large cup seat 33 is arranged below the cup seat lid 29; and a mashing assembly and a shredding assembly are arranged in the cup body 2.

Further, the mashing assembly is composed of a mashing cutterhead fixing seat 37 and a mashing cutterhead 38; the mashing cutterhead 38 is arranged below the mashing cutterhead fixing seat 37; the mashing cutterhead fixing seat 37 is connected to the mashing cutterhead 38 through a mashing shaft; and a bottom end of the mashing cutterhead 38 is fixedly connected with a shredding knife connecting shaft 39. The shredding assembly is composed of an upper shredding cutterhead fixing seat 41, a shredding cutterhead 42, and a lower shredding cutterhead fixing seat 43; an outer side wall of the shredding knife connecting shaft 39 is fixedly connected with a shredding insert 40; the shredding cutterhead 42 is respectively connected to the upper shredding cutterhead fixing seat 41 and the lower shredding cutterhead fixing seat 43; and an inner side wall of the lower shredding cutterhead fixing seat 43 is adapted to an outer side wall of a top end of a shredding knife rod 44.

It should be noted that: Different crushing and mixing modes are selected for different food materials. When a mashing mode is selected, a food material can be fed from a cup lid feeding window on the shredding lid 1, and the food material to be mashed can enter the mashing cutterhead 38 for mixing and crushing. When a shredding mode is selected, a food material can be fed from the small push rod 3 for shredding and the large push rod 4 for shredding on the shredding lid 1, so that the food material to be shredded enter the shredding cutterhead 42 for mixing and crushing.

A further advantage of the above solution is as follows: This can select shapes of crushed food materials for different food materials, to meet different use needs and achieve higher adaptability.

According to the present disclosure, during use, after a food material to be crushed and mixed is put into the cup body 2, the two cup lid connecting shafts 17 at the bottom end of the shredding lid 1 are aligned with the shaft holes at the handle 19 at the top end of the cup body 2; the entire shredding lid 1 is then closed and pressed downwards; pressing the shredding lid 1 downwards will press the cup lid sliding block 13 and the single cup lid sliding block 14 together; pressing the single cup lid sliding block 14 downwards may press its protruding portion to deform and enter the limiting slot provided on the inner side wall of the cup body 2; the down movement of the cup lid sliding block 13 will drive the connecting rod sliding blocks 6 to move down together, so that the connecting rod sliding blocks 6 will drive the cup lid connecting rods 8 to move downwards through the connecting rod hinges 7; and the down movement of the cup lid connecting rods 8 will drive the limiting sliding blocks 10 to move downwards, so that protruding portions of the limiting sliding blocks are pressed to deform and enter the limiting slots provided in the cup body 2, thereby completing the locking on the entire cup lid. After the crushing and mixing are completed, the release button 5 is pressed, and the release button 5 will compress the button spring 11 to downwards pass through the insertion hole provided on the button bracket 12. After the release button 5 is inserted into the two connecting rod sliding blocks 6, the two connecting rod sliding blocks 6 slide outwards, and the connecting rod sliding blocks 6 will rotate together with the connecting rod hinges 7. The connecting rod hinges 7 will rotate to drive the cup lid connecting rods 8 to rotate together, so that the cup lid connecting rods 8 rotate outwards, and the limiting sliding blocks 10 are separated from the limiting slots in the cup body 2. The release button 5 continues to move downwards to pass through the cup lid sliding block 13 and be inserted onto a slope of the single cup lid sliding block 14, making the single cup lid sliding block to slide inwards and be separated from the limiting slot of the cup body 2. This can quickly complete the locking on a square cup of the mixer, avoid spilling of the food material caused by a protrusion during mixing, and further facilitate quickly relieving the locking limitation after the mixing is completed. It is more convenient to use.

When the two cup lid connecting shafts 17 at the bottom end of the shredding lid 1 are aligned with the shaft holes at the handle 19 at the top end of the cup body 2 and are pressed, the cup lid connecting shafts 17 will press the left large cup ejector rod 20 and the right large cup ejector rod 21. When the left large cup ejector rod 20 and the right large cup ejector rod 21 are pressed, the two ejector springs 22 will be compressed for energy storage. After the subsequent crushing and mixing are completed, the release button 5 is pressed to relieve the locking limitation, and the left large cup ejector rod 20 and the right large cup ejector rod 21 may eject the two cup lid connecting shafts 17 under the action of the elastic force of the ejector springs 22, thereby making the entire shredding lid 1 to pop up. This can be convenient for a user to directly open the shredding lid 1 after the locking limitation is relieved, so that the operation of opening the shredding lid 1 is more convenient and quicker.

Different crushing and mixing modes are selected for different food materials. When a mashing mode is selected, a food material can be fed from a cup lid feeding window on the shredding lid 1, and the food material to be mashed can enter the mashing cutterhead 38 for mixing and crushing. When a shredding mode is selected, a food material can be fed from the small push rod 3 for shredding and the large push rod 4 for shredding on the shredding lid 1, so that the food material to be shredded enter the shredding cutterhead 42 for mixing and crushing. This can select shapes of crushed food materials for different food materials, to meet different use needs and achieve higher adaptability.

The above is only the specific implementation of the present disclosure, but the protection scope of the present disclosure is not limited to this. Equivalent replacements or changes made by any person skilled in the art within the technical scope disclosed in the present disclosure based on the technical solutions and concept of the present disclosure shall all fall within the protection scope of the present disclosure.

What is claimed is:

1. A lid structure for a mixer, comprising a shredding lid (1) and a cup body (2), wherein a small push rod (3) for shredding and a large push rod (4) for shredding are respectively arranged in the shredding lid (1); a bottom end of the shredding lid (1) is connected to a button bracket (12); a bottom end of the button bracket (12) is connected with a cup lid sliding block (13); a bottom end of the cup lid sliding block (13) is connected with a single cup lid sliding block (14); an inner side wall of a groove at a top end of the cup lid sliding block (13) is connected with two connecting rod sliding blocks (6); inner side walls of circular holes provided on the connecting rod sliding blocks (6) are connected with connecting rod hinges (7); pin shafts on the connecting rod hinges (7) are rotatably connected with cup lid connecting rods (8); the cup lid connecting rods (8) are connected with limiting sliding blocks (10) through reset springs (9); a trigger assembly is arranged on the button bracket (12); an outer side wall of the cup body (2) is connected with a handle (19); a pop-up assembly is arranged in the handle (19); a cup seat lid (29) is arranged in the cup body (2); a large cup seat (33) is arranged below the cup seat lid (29); and a mashing assembly and a shredding assembly are arranged in the cup body (2).

2. The lid structure of the mixer according to claim 1, wherein the bottom end of the button bracket (12) is fixedly connected to the top end of the cup lid sliding block (13); the bottom end of the cup lid sliding block (13) is slidably connected to a top end of the single cup lid sliding block (14); a side wall of the single cup lid sliding block (14) is fixedly connected with a cup lid buckle spring (15); and the other end of the cup lid buckle spring (15) is fixedly connected to the cup lid sliding block (13).

3. The lid structure of the mixer according to claim 1, wherein the trigger assembly is composed of a release button (5) and a button spring (11); the button spring (11) sleeves an outer side wall of the release button (5); a bottom end of the button spring (11) is fixedly connected to a top end of the button bracket (12); and an inner side wall of an insertion hole provided on the button bracket (12) is slidably connected to a side wall of the release button (5).

4. The lid structure of the mixer according to claim 1, wherein side walls of the two connecting rod sliding blocks (6) are slidably connected to an inner side wall of a sliding chute on the cup lid sliding block (13); inner side walls of shaft holes provided on the connecting rod sliding blocks (6) are rotatably connected to outer side walls of the pin shafts on the connecting rod hinges (7); bottom ends of the cup lid connecting rods (8) are slidably connected to the limiting sliding blocks (10); and two ends of the reset springs (9) are respectively fixedly connected to the cup lid connecting rods (8) and the limiting sliding blocks (10).

5. The lid structure of the mixer according to claim 1, wherein the limiting sliding blocks (10) and the single cup lid sliding block (14) are respectively movably connected to a transparent lid (16) for shredding; an outer side wall of the small push rod (3) for shredding and an outer side wall of the large push rod (4) for shredding are respectively movably connected to an inner side wall of the transparent lid (16) for shredding; a bottom end of the transparent lid (16) for shredding is fixedly connected with two cup lid connecting shafts (17); and a cup lid sealing ring (18) is arranged at the bottom end of the transparent lid (16) for shredding.

6. The lid structure of the mixer according to claim 1, wherein the pop-up assembly is composed of a left large cup ejector rod (20) and a right large cup ejector rod (21); an outer side wall of the cup body (2) is fixedly connected to two ends of the handle (19); side walls of the left large cup ejector rod (20) and the right large cup ejector rod (21) are slidably connected to an inner side wall of the handle (19); and bottom ends of the left large cup ejector rod (20) and the right large cup ejector rod (21) are fixedly connected with ejector springs (22).

7. The lid structure of the mixer according to claim 1, wherein a knife rod connecting head (23) is arranged in the cup body (2); a bottom end of the knife rod connecting head (23) is fixedly connected with a rotating shaft (24); an outer side wall of the rotating shaft (24) is connected with an upper gasket (25); a the bottom end of the rotating shaft (24) is connected with a bearing sleeve (26); and a bottom end of the bearing sleeve (26) is connected with an oil seal (27) and an oil bearing (28).

8. The lid structure of the mixer according to claim 1, wherein a bottom end of the cup seat lid (29) is adaptively connected to a top end of a large cup seat (33); a decorative ring (30) is arranged on an outer side wall of the large cup seat (33); a cup seat spring buckle (32) is arranged in the large cup seat (33); a top end of the cup seat spring buckle (32) is fixedly connected with a snap spring (31), a lower gasket (34) is provided on the bottom end of the cup seat spring buckle (32); and a bottom end of the large cup seat (33) is connected with a large cup connecting head (36) through a connecting nut (35).

9. The cover structure of the mixer according to claim 1, wherein the mashing assembly is composed of a mashing cutterhead fixing seat (37) and a mashing cutterhead (38); the mashing cutterhead (38) is arranged below the mashing cutterhead fixing seat (37); the mashing cutterhead fixing seat (37) is connected to the mashing cutterhead (38) through a mashing shaft; and a bottom end of the mashing cutterhead (38) is fixedly connected with a shredding knife connecting shaft (39).

10. The lid structure of the mixer according to claim 9, wherein the shredding assembly is composed of an upper shredding cutterhead fixing seat (41), a shredding cutterhead (42), and a lower shredding cutterhead fixing seat (43); an outer side wall of the shredding knife connecting shaft (39) is fixedly connected with a shredding insert (40); the shredding cutterhead (42) is respectively connected to the upper shredding cutterhead fixing seat (41) and the lower shredding cutterhead fixing seat (43); and an inner side wall of the lower shredding cutterhead fixing seat (43) is adapted to an outer side wall of a top end of a shredding knife rod (44).
